(19) United States
(12) Patent Application Publication
(10) Pub. No.: US 2002/0007399 A1
(43) Pub. Date: Jan. 17, 2002

(54) Email distribution on the edge

(75) Inventor: Peter Bernard Kaars, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/900,561

(22) Filed: Jul. 6, 2001

Related U.S. Application Data
(60) Provisional application No. 60/218,271, filed on Jul. 13, 2000.

(51) Int. Cl. G06F 15/16

(52) U.S. Cl. 709/206

(57) ABSTRACT

A service provider enables to distribute electronic content via a data network to a plurality of addressees. In order to do this, respective servers are identified, via which to deliver the content to respective groups among the plurality of the addressees. A copy of the content is then sent to the respective server. The respective server is enabled to send individual copies of the content to individual ones of the addressees in the respective group, e.g., based on the relevant e-mail addresses of the addressees in the respective group.

### FIELD OF THE INVENTION

The invention relates to distribution of electronic content, and in particular to e-mail broadcasts or distribution, e.g., in electronic direct marketing.

### BACKGROUND ART

E-mail distribution to large groups of subscribers or prospective customers is big business and is expected to grow. For this purpose copies of the same electronic message are sent to thousands of users. This type of email distribution uses a lot of bandwidth as the e-mails travel from one central e-mail server all through the network to the target addresses.

### SUMMARY OF THE INVENTION

The inventor therefore proposes a method of providing a service to enable a party, e.g., a marketing agency or a marketing department of a corporation, to distribute electronic content via a data network to a plurality of addressees. According to the method, specific edge servers are identified for delivery of the content to specific groups among the plurality of the addressees. A respective copy of the content is then sent to a respective one of the edge servers. Each specific edge server is enabled to send respective copies of the content to respective ones of the addressees in the specific group.

More generally, the invention relates to a method of providing a service to enable to distribute electronic content via a data network to a plurality of addressees. The service is provided by, e.g., a dedicated provider from a specific server network. According to the method, respective servers are identified, via which to deliver the content to respective groups among the plurality of the addressees. Then, a copy of the content is sent to the respective server; and the respective server is enabled to send individual copies of the content to individual ones of the addressees in the respective group. A list of identifiers, e.g., e-mail addresses of the addressees of the respective group, is supplied to the respective server. The content comprises, e.g., an e-mail message. Also, a first portion of the content is sent to the respective server, which is enabled to add a second portion to the first portion. Then, the respective server is enabled to send the first and second portions as electronic content to the individual addressees in the respective group. This aspect has advantages if part of the content is uniform to a specific group of addressees. For example, the second portion added by the server relates to geographical information relevant to this group such as a weather forecast, an address of a local or regional dealer, regional price lists, etc.

In the invention, the electronic content, e.g., an electronic message, is sent to a server that is close to the addressees: a so-called edge server, or a server on the edge of the network. An edge server is a server that is physically located close to a server of the ISP of the specific addressees, typically in a local commercial ISP facility. The number of edge servers in a region depends on the number of users in the region. This message to be distributed is sent to an edge server accompanied by a list of addressees residing close to that specific edge server. At the edge server, the message is expanded into a plurality of respective messages for each respective one of the relevant addressees on the list. Alternatively, the edge server further partitions the list of relevant addressees that it has received into respective sub-sets of addressees. The edge server forwards the respective sub-sets and a copy of the message per sub-set to further respective servers downstream of the first edge server. The latter is the case if a mail server has only part of the information to find the servers closest to the addressees, and delegates this task to the edge server first-in-line. An example of this is the internal server network structure of an ISP, which is not visible from the outside.

The invention significantly reduces bandwidth usage, as the electronic content is sent to a relatively small number of edge servers, from which a relatively large number of copies are sent to the relevant addressees. That is, the stage at which the copies are made is postponed until the edge server has been reached.

The invention differs from so-called e-mail reflectors. As known, e-mail can be distributed to lists of addressees as well as to an individual addressee. A shared distribution list can be centrally managed by an e-mail reflector. An e-mail reflector is a software program that serves as a forwarding broadcaster of e-mail messages to the addressees on a distribution list. A sender creates an e-mail message and sends the message to the e-mail reflector on the e-mail server. The e-mail reflector then automatically forwards a copy to each addessee on the pre-defined distribution list.

The invention can be applied to an e-mail reflector. The distribution list of the e-mail reflector can be segmented into respective clusters that correspond with respective edge servers based on the location of the server of the addressees' ISPs. The proper segment of the distribution list is sent to the corresponding edge server together with the content to be distributed. The edge servers then have the proper software to serve as a dynamic e-mail reflector, i.e. an e-mail reflector that receives its, possibly segmented distribution list on the fly.

Simple heuristics can be used to identify the location of a user. E.g., many users have email addresses associated with a certain Internet Service Provider (ISP) such as aol.com, yahoo.com. The location of their e-mail servers is known.

Similarly to other big corporations, these ISPs have their own data networks comprising multiple servers residing at different geographic locations. Inside such data networks the address of the server closest to the end-users is typically known.

Edge servers are already used on a large scale for frequently-accessed Web content, playing the role of a cache and are therefore also referred to as cache servers. Especially for streaming Audio and Video media, infrastructures have been built with edge servers, e.g., by Akamai Technologies, Inc. Akamai's EdgeAdvantage platform uses sophisticated algorithms to determine the location of a requesting user, and to determine the closest Akamai edge server from which to deliver content to the end user.

Finally the e-mail servers of users on other domains can be found from public registers. These registers are publicly accessible and cite the IP address as well as the physical location of the machine that hosts the concerning domain.

### BRIEF DESCRIPTION OF THE DRAWING

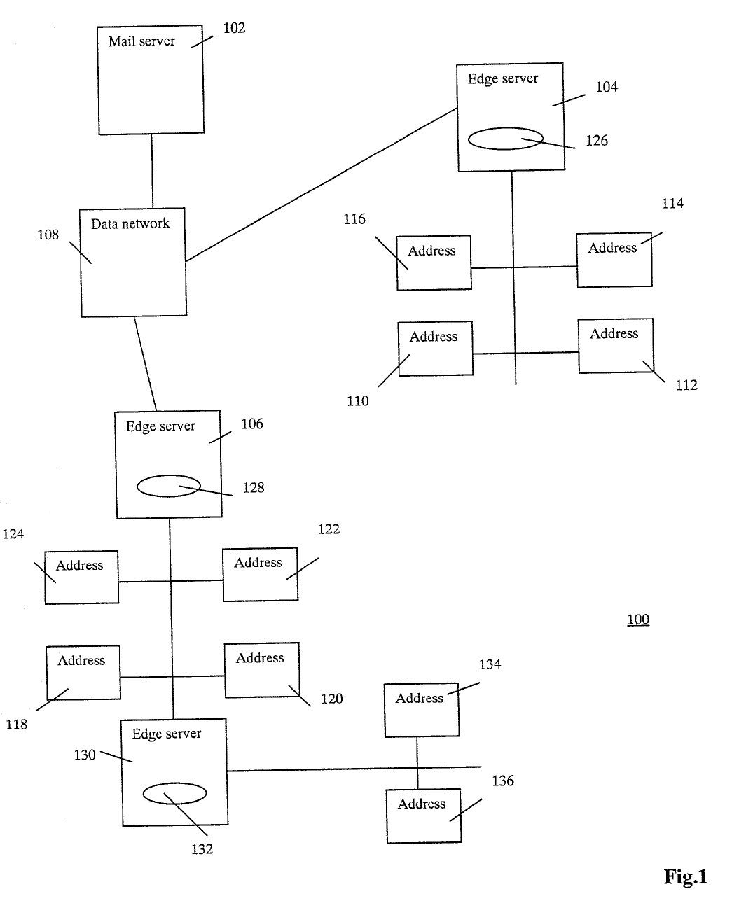

The invention is described in further detail below, by way of example, and with reference to the accompanying drawing, wherein FIG. 1 is a block diagram of a system in the invention.

### DETAILED EMBODIMENTS

FIG. 1 is a block diagram of a system 100 in the invention. System 100 comprises a mail server 102, and edge servers 104 and 106 connected to server 102 via a data network 108. Edge server 104 is close to mail addressees 110, 112, 114 and 116 and functions as an edge server to these addressees. Server 106 is close to addressees 118, 1120, 122 and 124, and functions as an edge server to these addressees.

Server 102 is instructed to distribute an email to each of addressees 110-124. Server 102 has a database of the addresses of each of addressees 110-124, together with a list of the specific edge server associated with each specific one of addressees 110-124. For example, the addresses of addressees 110-116 are associated with edge server 104, and the addresses of addressees 118-124 are associated with edge server 106. The database and lists have been obtained, e.g., through uploading from each server in system 100 a corresponding list of local addresses for which the relevant server acts as an edge server, and possibly filtering out the irrelevant addresses. Alternatively, the lists of addresses and associated edge servers have been obtained in advance through monitoring the data network traffic, e.g., using the system of Akamai Technologies, Inc. Other methods to obtain these email lists may be used as well.

Accordingly, a copy of the email gets sent to edge server 104 with a list of addresses of addressees 110-116, and another copy gets sent to edge Server 106 with addresses of addressees 118-124. Edge servers 104 and 106 invoke software 126 and 128 (e.g., a script or an application) to create copies for each of the associated addresses in the list and to have the copies sent to the individual addresses.

Edge server 106 may have to sent a single copy of the message to a further edge server 130 together with a sub-set of addresses received by edge server 106 for addresses 134 and 136. Edge server 130 expands the message and prepares copies for each of addresses 134 and 136 sends the message to each individual one of addresses 134-136.

Incorporated by reference herein is U.S. Ser. No. 09/642,713 (attorney docket U.S. 000213) filed Aug. 21, 2000 for Leila Kaghazian for SELECTIVE SENDING OF PORTIONS OF ELECTRONIC CONTENT. This document relates to enabling a user of a hand-held communication device to select in a foreground process portions of an electronic document. In a background process a new document is prepared that comprises the selected portions. The user selects the address for forwarding the new document, and the new document gets sent in a background process.

What is claimed is:

1. A method of providing a service to enable to distribute electronic content via a data network to a plurality of addressees, the method comprising:
identifying respective servers via which to deliver the content to respective groups among the plurality of the addressees;
sending one copy of the content to the respective server; and
enabling the respective server to send individual copies of the content to individual ones of the addressees in the respective group.

2. The method of claim 1, wherein the enabling to distribute comprises supplying a list of identifiers of the addressees of the respective group to the respective server.

3. The method of claim 1, wherein the content comprises an e-mail.

4. The method of claim 1, comprising
sending a first portion of the content to the respective server;
enabling the respective server to add a second portion to the first portion; and
enabling the respective server to send the first and second portions to the individual addressees in the respective group.

5. A method of distributing electronic content via a data network to a plurality of addressees, the method comprising:
identifying respective servers via which to deliver the content to respective groups among the plurality of the addressees;
sending one copy of the content to the respective server; and
enabling the respective server to send individual copies of the content to individual ones of the addressees in the respective group.

6. The method of claim 5, wherein the enabling to distribute comprises supplying a list of identifiers of the addressees of the respective group to the respective server.

7. The method of claim 5, wherein the content comprises an e-mail.

8. The method of claim 5, comprising
sending a first portion of the content to the respective server;
enabling the respective server to add a second portion to the first portion; and
enabling the respective server to send the first and second portions to the individual addressees in the respective group.

9. Electronic content with a list of addressees for receiving the content via a data network, the list being based on the addressees being addressable through a specific edge server.

10. Software for, upon receipt of a combination of electronic content and a list of addressees, generating individual copies of the content for individual ones of the addressees.
